(19) United States
(12) Patent Application Publication
(10) Pub. No.: US 2005/0216687 A1
(43) Pub. Date: Sep. 29, 2005

(54) DATA MANAGING METHOD AND DATA ACCESS SYSTEM FOR STORING ALL MANAGEMENT DATA IN MANAGEMENT BANK OF NON-VOLATILE MEMORY

(76) Inventor: Hung-Shiun Fu, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/906,999

(22) Filed: Mar. 15, 2005

Related U.S. Application Data
(60) Provisional application No. 60/521,296, filed on Mar. 28, 2004.

(30) Foreign Application Priority Data
Nov. 18, 2004 (TW) 093135492

(51) Int. Cl. G06F 12/00

(52) U.S. Cl. 711/165; 711/103; 711/159

(57) ABSTRACT

A data managing method and a data access system for storing management data in a management bank of a non-volatile memory. The data managing method includes dividing the non-volatile memory into a plurality of banks, wherein each of the banks contains an attribute field. When an attribute field of a first bank stores a first value and the first bank is full, the data managing method finds a second bank with an attribute field storing a second value, copies valid data stored in the first bank into the second bank, assigns the first value to the attribute field of the second bank, and erases all data originally stored in the first bank.

### CROSS REFERENCE TO RELATED APPLICATIONS

This application claims the benefit of U.S. provisional application No. 60/521,296, which was filed on Mar. 28, 2004 and entitled “Flash Memory Management”.

### BACKGROUND

The present invention relates to a data managing method and a data access system, and more specifically, to a data managing method and a data access system for storing management data in a management bank of a non-volatile memory.

With developments of electronic devices, the amount of electronic devices using non-volatile memory to store digital information is more than ever before. For example, a flash memory can be applied in a digital camera or a cellular phone for storing user data. Generally speaking, a flash memory is composed of a plurality of erase units and has some limitations due to the design and the materials of the flash memory. For example, if data exists at an address of the flash memory, it is impossible to write new data into that address before the data at that address is erased. Typically, an erase unit consists of one or more contiguous erase blocks. An erase block is the smallest contiguous area that can be erased in a single erase operation. For a flash memory, data is written into an erase unit in a specific direction, from the beginning to the end of the erase unit, until the erase unit is full. Then another erase unit with free space is selected to be utilized for storing data. If an erase unit is full of data and some new data is going to be stored into the full erase unit, the new data can be stored into the erase unit only after the data originally stored in the erase unit is erased.

A limitation of Flash memory technology is that the number of times an erase unit can be erased is inherently limited by the physics of the Flash memory. Software or logical modules are needed for performing wear leveling operations on the flash memory. Therefore, user data can be distributed throughout the flash memory to make the erase cycle (wear level) of each erase unit as even as possible, therefore the life of the flash memory can be extended. However, when storing not only the general data (user data) but also the management data, like a user data file map for managing user data, into the flash memory, it faces two choices. One choice is to perform identical operation(s) for storing the general data or the management data to the flash memory. However, in this way, the management data would be distributed throughout the flash memory, which results in the inconvenience for reading the management data. Moreover, when booting a computer, it is necessary to spend time for finding the management data distributed throughout the flash memory and the general data. The other choice is to gather and store the management data in a dedicated section of the flash memory. In this way, the management data will not be mixed up with user data, so it is easy and convenient to manage the management data, and the management data can be quickly found when booting the system. However, the frequency of updating management data is usually greater than the frequency of updating user data, so the erase cycle of the section of the flash memory storing management data would be much higher than the erase cycles of the other sections where a wear leveling operation is performed and general data is stored into. Therefore, storing management data into a dedicated section of the flash memory results in shortening the life of the flash memory due to the need to frequently update management data.

### SUMMARY

One of the objectives of the claimed invention is therefore to provide a data managing method and a data access system for storing all management data in a management bank of a non-volatile memory to solve the above-mentioned problem.

According to the claimed invention, a data managing method for storing management data in a management bank of a non-volatile memory is disclosed. The data managing method comprises: dividing the non-volatile memory into a plurality of banks, wherein each of the banks contains an attribute field; and when an attribute field of a first bank stores a first value and the first bank is full, the data managing method proceeding to following steps: finding a second bank with an attribute field storing a second value; copying valid data stored in the first bank into the second bank; assigning the first value to the attribute field of the second bank; and erasing all data originally stored in the first bank.

In addition, the claimed invention provides a data access system. The data access system comprises: a non-volatile memory comprising a plurality of banks, wherein each of the banks contains an attribute field; a data access module electrically connected to the non-volatile memory for writing data into a bank of the non-volatile memory; a data erasing module electrically connected to the non-volatile memory for erasing data stored in a bank of the non-volatile memory; and a control module electrically connected to the data access module, the data erasing module and the non-volatile memory for checking an attribute field and remaining space of a first bank; wherein if the attribute field of the first bank stores the first value and the first bank is full, the control module finds a second bank with an attribute field storing a second value, controls the data access module to copy valid data stored in the first bank into the second bank and to assign the first value to the attribute field of the second bank, and controls the data erasing module to erase all data originally stored in the first bank.

The data managing method and the data access system according to the claimed invention gather management data and store the management data in a management data bank of the flash memory for the convenience of managing and updating the management data. Therefore, the complexity of updating and searching management data can be decreased. Also, the management data of the flash memory can be found in a short time and the time for starting the electronic device can be speeded up. In addition, the need of wear leveling of the flash memory is satisfied to extend the life of the flash memory.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional block diagram of a data access system according to the present invention.

FIG. 2 is a diagram of a bank shown in FIG. 1.

FIG. 3 is a state transition diagram of the banks shown in FIG. 1.

FIG. 4 is a flowchart describing how the data access system shown in FIG. 1 updates the management data.

FIG. 5 to FIG. 9 are diagrams of a flow describing that a wear leveling operation is performed on the flash memory shown in FIG. 1.

### DETAILED DESCRIPTION

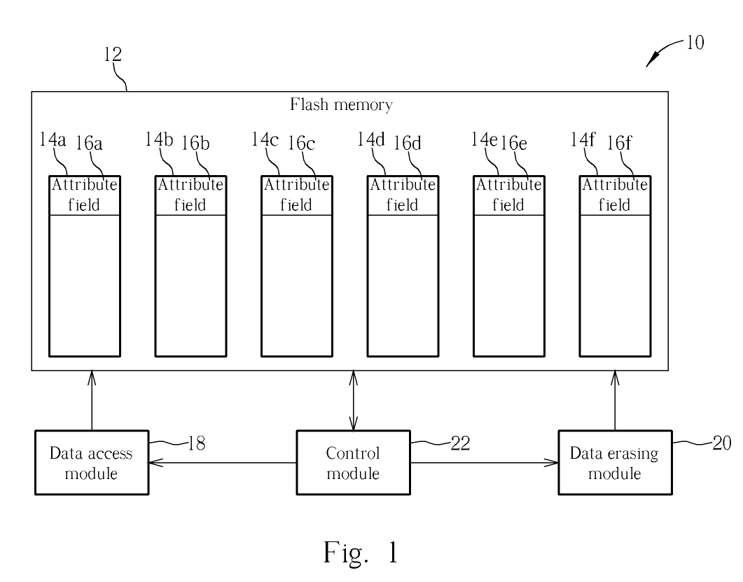

Please refer to FIG. 1. FIG. 1 is a functional block diagram of a data access system 10 according to the present invention. The data access system 10 comprises a flash memory 12, a data access module 18, a data erasing module 20, and a control module 22. The flash memory 12 comprises a plurality of banks. Each bank contains an attribute field. An attribute field of a bank is utilized for identifying the attribute of data stored in the bank. Each bank consists of a plurality of contiguous erase blocks of the flash memory 12. An erase block is the smallest contiguous area in the flash memory 12 that can be erased in a single erase operation. In the present embodiment, each bank has the same size. The erase unit according to the present invention is called a bank. As shown in FIG. 1, the flash memory 12 comprises six banks, which are banks 14a, 14b, 14c, 14d, 14e and 14f, containing attribute fields 16a, 16b, 16c, 16d, 16e and 16f, respectively. In addition, the attribute fields 16a, 16b, 16c, 16d, 16e and 16f are located at specific locations of the banks 14a, 14b, 14c, 14d, 14e and 14f, respectively, for example, at the very beginning of the banks 14a, 14b, 14c, 14d, 14e and 14f, respectively. The purpose of using attribute fields 16a, 16b, 16c, 16d, 16e and 16f will be described later.

The data access module 18 is electrically connected to the flash memory 12 for writing data (not shown) into a bank of the flash memory 12. The data erasing module 20 is electrically connected to the flash memory 12 for erasing data stored in a bank of the flash memory 12. The control module 22 is electrically connected to the data access module 18, the data erasing module 20 and the flash memory 12 for controlling the data access module 18 to write data into a bank of the flash memory 12 or to assign one of the values V_{E}, V_{D}, or V_{M} to the attribute field of a bank. The value V_{E} represents that the bank is an empty bank, the value V_{D} represents that the bank is a general data bank, and the value V_{M} represents that the bank is a management data bank. In the present embodiment, V_{E}=11, V_{D}=1 0, V_{M}=01. Additionally, the control module 22 can control the data erasing module 20 to erase the whole data stored in a bank of the flash memory 12, including the value stored in the attribute field of the bank, which results in that the attribute field of the bank stores the predetermined value V_{E} without performing any additional value assigning operation specific for the attribute field of the bank. The value V_{E} stored in the attribute field represents that the bank is an empty bank. The detailed description of the data access system 10 will be described later.

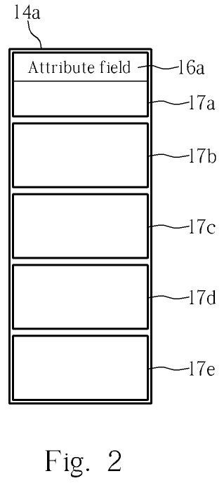

As mentioned above, each of the banks 14a, 14b, 14c, 14d, 14e and 14f has a plurality of erase blocks. The bank 14a is taken as an example. Please refer to FIG. 2. FIG. 2 is a diagram of the bank 14a shown in FIG. 1. The bank 14a comprises, as an example, five erase blocks 17a, 17b, 17c, 17d, and 17e of the flash memory 12. The attribute field 16a falls at the erase block 17a. Although there are five erase blocks 17a, 17b, 17c, 17d and 17e shown in FIG. 2, it should be noted that according to the present invention, the number of the erase blocks of a bank is not limited to a specific number, and the number of the erase blocks can be adjusted according to the amount of management data.

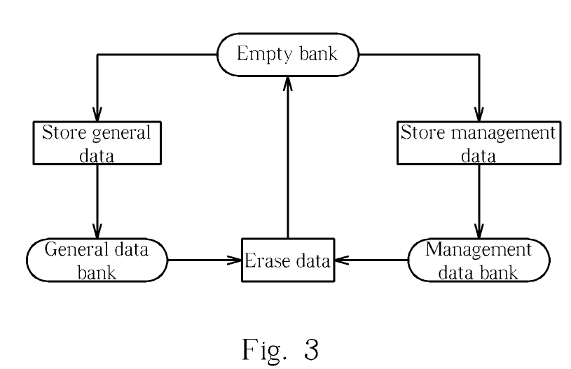

Please refer to FIG. 3. FIG. 3 is a state transition diagram of the banks 14a, 14b, 14c, 14d, 14e and 14f shown in FIG. 1. Each of the banks 14a, 14b, 14c, 14d, 14e and 14f has three possible states: to be an empty bank, a management data bank or a general data bank. If a bank is of an empty bank, it means that after all data in the bank is erased, there is no valid data further written into the bank, which means the content of the empty bank comprises the same logical values, like a plurality of logical values “1” (or “0”). Therefore, the attribute field of the empty bank records a value V_{E}=“11” (or V_{E}=“00”) without any additional value assigning operation. If management data, such as the erase cycles of the banks 14a, 14b, 14c, 14d, 14e and 14f, are going to be written into an empty bank, the attribute field of the bank is changed from the original value V_{E} to new value V_{M} to represent that the bank becomes a management data bank. Please note that the management data bank does not store any general data (i.e. user data). If general data is going to be written into an empty bank, the attribute field of the bank is changed from the original value V_{E} to new value V_{D} to represent that the bank becomes a general data bank. It should be noted that a general data bank does not store management data.

However, when a bank (a management data bank or a general data bank) is full and new data is going to be stored into the full bank, it is necessary to erase data stored in the full bank before any further data can be written into. That is, data stored in the erase blocks of the full bank needs to be sequentially erased, including the data in the attribute field of the bank. So the bank becomes an empty bank and the attribute field of the bank stores the value V_{E}=“11”. Therefore, as mentioned above, the data access system 10 can recognize the bank as a management data bank, an empty bank or a general data bank by checking the attribute field of the bank. Additionally, if data (general data or management data) stored in the bank is the latest data or data that needs to be utilized later, the data is defined as valid data; otherwise, the data is defined as invalid data.

Assuming that the present management data bank of the data access system 10 is the bank 14c. The banks 14e are 14f are empty banks, and the banks 14a, 14b and 14d are general data banks. Because the bank 14c is the present management data bank, the control module 22 drives the data access module 18 to assign the value “01” to the attribute field 16c of the bank 14c, and all management data are gathered and stored in the bank 14c. Hence, any operation of storing or updating management data is only performed in the bank 14c. When an electronic device, like a computer or a cellular phone, in which the data access system 10 is installed is powered on, the control module 22 checks values stored in the attribute fields 16a, 16b, 16c, 16d, 16e and 16f of the banks 14a, 14b, 14c, 14d, 14e and 14f, respectively, to find the management data bank of the flash memory 12. The control module 22 needs to check values stored in the attribute fields 16a, 16b, 16c, 16d, 16e and 16f one at a time for at most six times, wherein “six” is the number of the banks of the flash memory 12. Then, the control module 22 can locate and obtain all the management data. Compared with the related art, according to which management data are distributed throughout a flash memory, the data access system 10 according to the present invention can omit searching the whole flash memory 12 for the management data and therefore speed up the time for starting the electronic device.

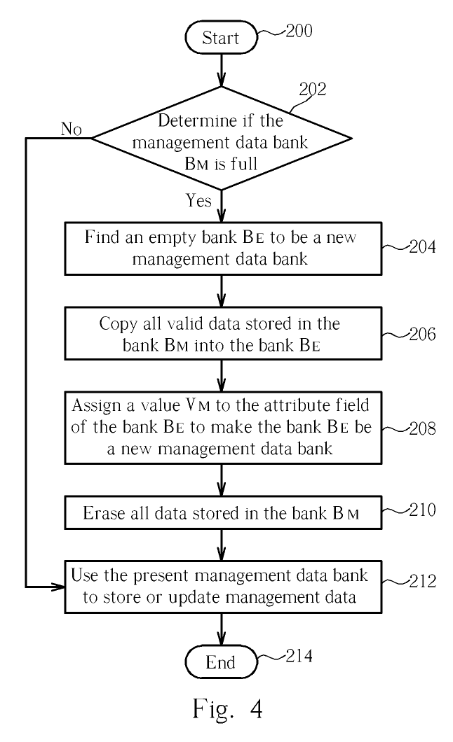

Please refer to FIG. 4. FIG. 4 is a flowchart describing how the data access system 10 shown in FIG. 1 updates the management data. The operation of updating management data performed by the data access system 10 comprises the following steps:

Step 200: Start.

Step 202: Determine if the management data bank B_{M} is full. If so, proceed to step 204; otherwise, proceed to step 212.

Step 204: Find an empty bank B_{E} to be a new management data bank.

Step 206: Copy all valid data stored in the bank B_{M} into the bank B_{E}.

Step 208: Assign the value V_{M} to the attribute field of the bank B_{E} to make the bank B_{E} be a new management data bank.

Step 210: Erase all data stored in the bank B_{M}.

Step 212: Use the present management data bank to store or update management data.

Step 214: End.

The detailed description of the above-mentioned flow is described as follows. Please read the detailed description while referring to FIG. 1. As above-mentioned, assuming the present management data bank of the data access system 10 is the bank 14c, the control module 22 controls the data access module 18 to update management data, which means to sequentially write new management data into the bank 14c. However, the control module 22 needs to check if there is any space in the bank 14c for storing new management data; that is, to determine if the bank 14c is full (step 202). For example, if remaining space in the bank 14c is not large enough for storing new management data, or the remaining space in the bank 14c is less than a threshold value, the control module 22 determines that the bank 14c is full. The above-mentioned methods or equivalent methods for determining if a bank is full are all covered by the present invention.

If there is enough space in the bank 14c for storing new management data, the control module 22 controls the data access module 18 to write the new management data into the present management data bank, the bank 14c (step 212). However, if the bank 14c is full, the control module 22 needs to find an empty bank to be a new management data bank. Also, for satisfying the need of wear leveling of the flash memory 12, the control module 22 selects an empty bank with a smallest erase cycle from empty banks of the flash memory 12. For example, the empty bank 14e is selected to be the new management data bank in the present embodiment (step 204). At this time, the bank 14c (the old management data bank) is full, and the management data stored in the bank 14c contains both valid and invalid data, like the latest management data that is viewed as valid data and needs to be kept. Therefore, the control module 22 controls the data access module 18 to copy all valid data stored in the bank 14c into the bank 14e (the new management data bank) (step 206). Next, the control module 22 drives the data access module 18 to assign the value V_{M} to the attribute field 16e of the bank 14e to mark the bank 14e as the present management data bank (step 208). Afterwards, the control module 22 controls the data erasing module 20 to erase all data stored in the bank 14c, including invalid data and the value stored in the attribute field 16c. In other words, the bank 14c becomes an empty bank, and at this time, the value of the attribute field 16c of the bank 14c is the value V_{E} (step 210). Then, the control module 22 controls the data access module 18 to write new management data into the present management data bank, the bank 14e (step 212), to complete the operation of updating management data (step 214).

In this way, if there is at least one empty bank in the data access system 10, management data can be successfully updated and stored by changing management data bank if necessary. Also, the data access system 10 can determine which bank the present management data bank is according to the values stored in the attribute fields of the banks. The data access system 10 and the data managing method according to the present invention decrease the complexity of updating and searching management data. In addition, as mentioned above, when writing management data into a management data bank, for satisfying the need of wear leveling of the flash memory 12, the control module 22 selects an empty bank with a smallest erase cycle from empty banks of the flash memory 12. Compared with the related art, in the present invention, management data is not stored in a dedicated bank, therefore it will not result in the erase cycle of a specific bank quickly accumulating to a maximum limitation number. That is, each bank of the flash memory 12 can be utilized for properly storing data for a long time, and management data can be properly and continuously stored and read. Therefore, the life of the flash memory 12 will be extended.

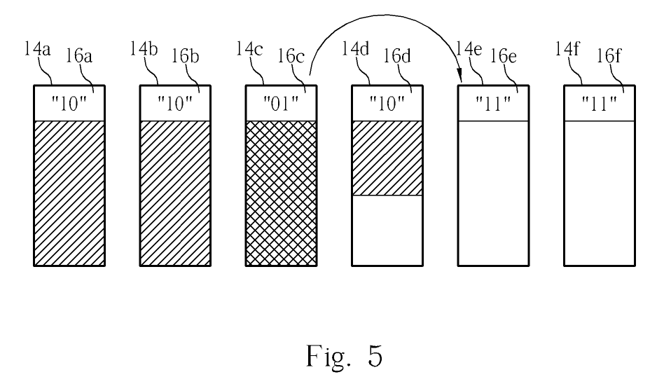

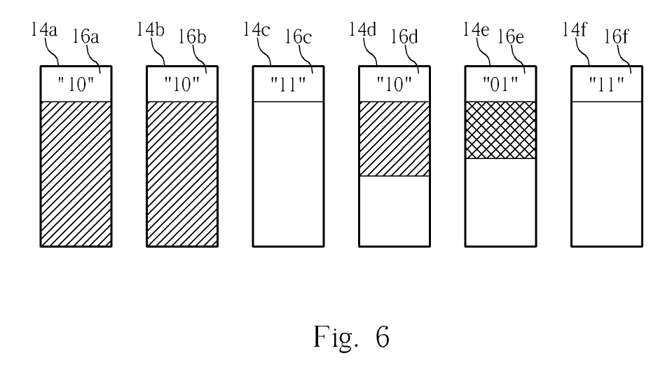

Please refer FIG. 5 to FIG. 9. FIG. 5 to FIG. 9 are diagrams of a flow describing that a wear leveling operation is performed on the flash memory 12 shown in FIG. 1. When writing management data or general data, a wear leveling operation is performed on the flash memory 12 to extend the life of the flash memory 12. When the management data bank 14c is full of management data and cannot store new management data, the control module 22 compares the erase cycles of the empty banks to select an empty bank with a minimal erase cycle, such as the bank 14e shown in FIG. 5. The bank 14e is determined to be a new management data bank in the flash memory 12. Next, the control module 22 controls the data access module 18 to copy all valid data stored in the bank 14c (the old management data bank) into the bank 14e (the new management data bank), and then controls the data erasing module 18 to erase data stored in the bank 14c, so the bank 14c becomes an empty bank. The result is shown in FIG. 6. Afterwards, the management data can be written into the bank 14e until the bank 14e is full.

When updating general data, the management data is usually updated associatedly, and the detailed operation of updating or writing management data is described in the above-mentioned description. For updating or writing general data into a general data bank, after the general data bank is full, if there is more than one empty bank in the flash memory 12, one of the empty banks is selected to be a next general data bank for storing general data. Then the control module 22 controls the data access module 18 to assign the value V_{D} to the attribute field of the selected empty bank, which makes the selected empty bank become a general data bank. In other words, after a general data bank is full, the control module 22 just needs to find another empty bank to be a new general data bank. However, when there is just one empty bank in the flash memory 12, it is necessary for the data access system 10 to execute a garbage collection procedure, and the detailed description of the garbage collection procedure will be given later.

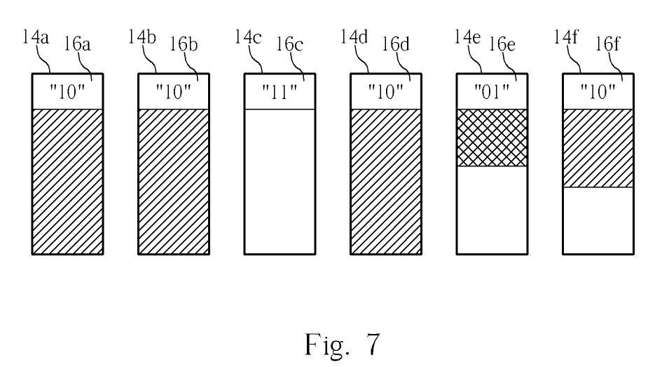

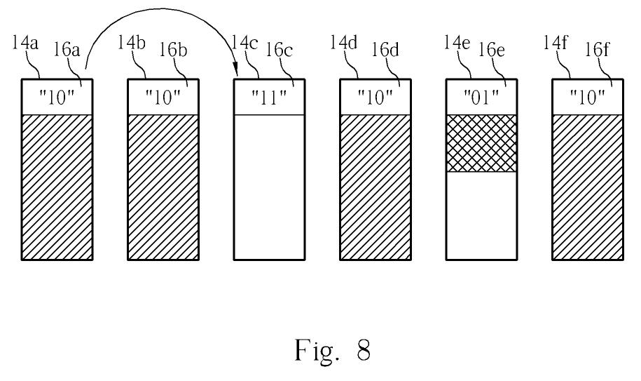

As shown in FIG. 6, there is still available space in the bank 14d (a general data bank) for storing general data. After the bank 14d is full, the control module 22 selects an empty bank with a smallest erase cycle from empty banks (the banks 14c and 14f) of the flash memory 12. For example, the empty bank 14f is selected in the present embodiment. Next, the control module 22 controls the data access module 18 to assign the value V_{D} to the attribute field 16f of the bank 14f to make the bank 14f be a general data bank, so the bank 14f can be utilized for storing new general data. The result is shown in FIG. 7. Then, after the bank 14f is full and there is only one empty bank (the bank 14c) in the flash memory 12, the data access system 10 needs to perform the above-mentioned garbage collection procedure. Firstly, it is necessary to select a target bank for the garbage collection procedure from the banks 14a, 14b, 14d, 14e and 14f, wherein the target bank can be a general data bank or a management data bank originally. Next, the control module 22 controls the data access module 18 to read management data stored in the management data bank 14e to know the erase cycles of the banks 14a, 14b, 14d, 14e and 14f. Then, the control module 22 selects a bank with the smallest erase cycle to be the target bank. As an example, the bank 14a is selected to be the target bank, as shown in FIG. 8.

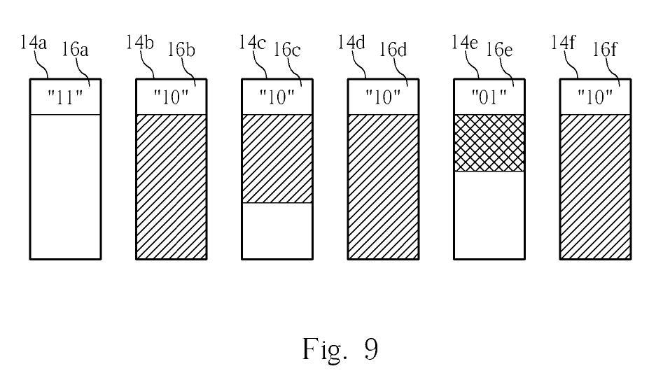

Afterwards, the control module 22 controls the data access module 18 to copy the valid general data stored in the bank 14a into the only one empty bank 14c and to assign the value V_{D} to the attribute field 16c of the bank 14c. Next, the control module 22 controls the data erasing module 20 to erase all data stored in the bank 14a, so the bank 14a becomes an empty bank and can be utilized for storing new data, as shown in FIG. 9. When selecting a target bank for a garbage collection procedure, it is necessary to take the need of wear leveling of flash memory 12 into account. Also, it is necessary to take the need of wear leveling of flash memory 12 into account when selecting an empty bank to be a next management data bank. Therefore, according to the present embodiment, even though it is obvious that the frequency of updating management data is greater than the frequency of updating general data, the goal of satisfying the need of wear leveling of the flash memory 12 can still be achieved by performing the operation of updating the management data and changing the management bank according to the present invention.

It should be noted that the utilization of attribute fields is just one way to identify the banks and to indicate whether a bank is a management data bank, a general data bank or an empty bank. Other ways can also be utilized for achieving the above-mentioned functions. In addition, though a flash memory is utilized in the present embodiment, the data managing method according to the present invention is not limited to be applied in a flash memory. That is, the data managing method can be applied in any data access storage device that has similar characteristics and functions as those of a flash memory. For example, if a section of the data access storage device has stored data and some new data tends to be stored in the section, it is necessary to erase the data stored in the section and then the new data can be written into the section. Also, the data access storage device should be able to be divided into a plurality of banks. The plurality of banks can be divided into two kinds of banks, management data banks and general data banks, according to the content of data stored in the banks.

In contrast to the related art, the data managing method and the data access system according to the present invention gather management data and store the management data in a management data bank of the flash memory for conveniently managing and updating the management data. Therefore, the complexity of updating and searching management data can be decreased. Also, the location of management data of the flash memory can be found in a short time and the time for starting the electronic device can be speeded up. In addition, the need of wear leveling of the flash memory is satisfied for extending the life of the flash memory.

Those skilled in the art will readily observe that numerous modifications and alterations of the device and method may be made while retaining the teachings of the invention. Accordingly, the above disclosure should be construed as limited only by the metes and bounds of the appended claims.

1. A data managing method for storing management data in a management bank of a non-volatile memory, comprising:
(a) dividing the non-volatile memory into a plurality of banks, wherein each of the banks contains an attribute field; and
(b) when an attribute field of a first bank stores a first value and the first bank is full, the data managing method proceeding to following steps:
(b1) finding a second bank with an attribute field storing a second value;
(b2) copying valid data stored in the first bank into the second bank;
(b3) assigning the first value to the attribute field of the second bank; and
(b4) erasing all data originally stored in the first bank.

2. The data managing method of claim 1, wherein step (b) further comprises: (b5) assigning the second value to the attribute field of the first bank.

3. The data managing method of claim 1, wherein in step (b4), the data in the first bank to be erased comprises the data stored in the attribute field, and after erasing the data, the value of the attribute field is the second value.

4. The data managing method of claim 1, wherein an attribute field of each bank is located at the very beginning of the bank.

5. The data managing method of claim 1, wherein each bank has the same memory size.

6. The data managing method of claim 1, wherein in step (b1), the second bank is the bank with smallest erase cycle in the banks whose attribute fields store the second values.

7. The data managing method of claim 1, wherein the first bank is a management data bank, and the second bank is an empty bank.

8. A data access system, comprising:
a non-volatile memory comprising a plurality of banks, wherein each of the banks contains an attribute field;
a data access module electrically connected to the non-volatile memory for writing data into a bank of the non-volatile memory;
a data erasing module electrically connected to the non-volatile memory for erasing data stored in a bank of the non-volatile memory; and
a control module electrically connected to the data access module, the data erasing module and the non-volatile memory for checking an attribute field and remaining space of a first bank; wherein if the attribute field of the first bank stores the first value and the first bank is full, the control module finds a second bank with an attribute field storing a second value, controls the data access module to copy valid data stored in the first bank into the second bank and to assign the first value to the attribute field of the second bank, and controls the data erasing module to erase all data originally stored in the first bank.

9. The data access system of claim 8, wherein the control module is further utilized for assigning the second value to the attribute field of the first bank.

10. The data access system of claim 8, wherein the control module drives the data erasing module to erase all data stored in the first bank, including the value stored in the attribute field of the first bank, and after erasing all the data, the value of the attribute field is the second value.

11. The data access system of claim 8, wherein an attribute field of each bank is located at the very beginning of the bank.

12. The data access system of claim 8, wherein each bank has the same memory size.

13. The data access system of claim 8, wherein the second bank found by the control module is the bank with smallest erase cycle in the banks whose attribute fields store the second values.

14. The data access system of claim 8, wherein the first bank is a management data bank, and the second bank is an empty bank.
